(19) United States
(12) Patent Application Publication
(10) Pub. No.: US 2011/0061227 A1
(43) Pub. Date: Mar. 17, 2011

(54) Assembly of die ejecting device and image capture device

(76) Inventors: Chia-Chun Tsou, Jhonghe City (TW); Po Lun Shih, Jhonghe City (TW); Ying-Ming Hung, Jhonghe City (TW)

(21) Appl. No.: 12/805,670

(22) Filed: Aug. 12, 2010

(30) Foreign Application Priority Data
Aug. 12, 2009 (TW) 98/127,046

(51) Int. Cl. B23P 21/00

(52) U.S. Cl. 29/705

(57) ABSTRACT

An assembly of a die ejecting device and an image capture device includes: an ejector main body; the die ejecting device provided on the ejector main body and configured for ejecting a die adhered to a tape; and the image capture device provided inside the die ejecting device and including: an image capture element for taking images of the ejected die; and an internal light source. Thus, not only can images be simultaneously taken of a die in a wafer and a waiting-to-be-bonded position, but also subsequent die testing and position calibration are made easy. The die can be directly bonded to a die bonding position on a substrate from below, thereby sparing the programs and mechanisms otherwise required for conveying the die with a pick-and-place arm. Consequently, the die transportation time and overall bonding cycle time are shortened, and the production capacity of the die bonding machine is enhanced.

### BACKGROUND OF THE INVENTION

1. Technical Field

The present invention relates to an assembly of a die ejecting device and an image capture device. More particularly, the present invention relates to an assembly of a die ejecting device and an image capture device, wherein the image capture device is disposed inside the die ejecting device and configured to simultaneously take images of a die in a wafer from below the wafer and thereby facilitate positioning of the die, and wherein the assembly also allows the die to be bonded to a die bonding position directly from the wafer.

2. Description of Related Art

During the manufacturing process of integrated circuits, a wafer is formed with the desired circuits, and after the wafer is cut into dies, the dies are adhesively mounted on a tape (such as a blue tape). Each die is ejected by an ejecting device below the wafer so as to be bonded to a substrate. Before the die is bonded, images are taken of the die by a camera not only to determine the quality of the die, but also to determine if the die is properly positioned, so that the die can be adjusted in position and be easily picked up by a pick-and-place arm.

Moreover, speed is a crucial factor for equipment used in semiconductor fabrication processes, and it has always been an important goal to produce the largest number of products within the shortest time frame. As it is often necessary to transport dies continuously from one place to another during the back-end manufacturing processes of semiconductor products, the techniques of picking up and placing dies are critical. Hence, mechanisms for rapidly picking up and placing dies play a vital role.

The conventional mechanism for bonding a die to a substrate requires the pick-and-place arm to be constantly moving and therefore it is not suitable for use with large substrates, in which case the moving distance of the pick-and-place arm would be needlessly long during the die bonding process, thus consuming a lot of time but with low throughput.

Referring to FIG. 1 for a conventional die ejecting device disclosed in Taiwan Patent (Utility Model) No. 335788, the die ejecting device includes a stage 11, a needle (not shown) which is disposed below the stage 11 and can be driven upward to project out of the stage 11, and an image capture device 12 which is disposed above the stage 11 and configured to take images of a die on the stage 11 from above. After images of the die are taken, the die is transported by a pick-and-place arm to a predetermined position, waiting to be bonded.

FIG. 2 shows a conventional assembly of a die ejecting device and an image capture device, wherein the assembly includes a supporting frame 13, a die ejecting device 14 provided on the supporting frame 13, and an image capture device 15 located below the plane defined by a stage of the die ejecting device 14. The image capture device 15 serves to take images of an ejected die and thereby facilitates subsequent die testing and position calibration.

It can be known from the foregoing description that the conventional assembly of a die ejecting device and an image capture device still has its shortcomings and inconveniences in structure as well as in use and needs further improvement. In order to overcome the aforesaid problems, related manufacturers have strived to find solutions, but suitable designs have been yet to be developed. Now that commercially available products are not specifically configured to address the above issues, it is imperative for the related industry to devise a novel assembly of a die ejecting device and an image capture device.

### BRIEF SUMMARY OF THE INVENTION

It is an object of the present invention to provide a novel assembly of a die ejecting device and an image capture device that overcomes the shortcomings of the prior art. The technical problem to be solved includes locating the image capture device inside the die ejecting device so as to not only facilitate subsequent die testing and position calibration, but also reduce the programs and mechanisms otherwise required for picking up, transporting, and placing dies, thereby providing a very useful assembly that is capable of shortening the overall bonding cycle time and increasing the production capacity of die bonding machines.

The foregoing object of the present invention, as well as the solution adopted by the present invention to solve the aforementioned technical problems, is achievable by an assembly of a die ejecting device and an image capture device, wherein the assembly includes: an ejector main body; the die ejecting device, which is provided on the ejector main body and configured for ejecting a die adhered to a tape; and the image capture device, which is provided inside the die ejecting device and includes: an image capture element for taking images of the ejected die; and a light source.

The foregoing object of the present invention, as well as the solution adopted by the present invention to solve the aforementioned technical problem, is also achievable by the following.

Preferably, the die ejecting device includes: an ejecting stage having a needle passing hole; a needle unit, which is located below the ejecting stage; and a driving unit, which is configured to drive the needle unit to project upward from the ejecting stage through the needle passing hole.

Preferably, the light source is a light-emitting diode (LED) light source and is located beside the image capture element.

The assembly according to the present invention of the die ejecting device and the image capture device at least provides the following advantageous effects. First, with the image capture device being placed inside the die ejecting device, not only can images be simultaneously taken from below a wafer, of a die in the wafer and of a waiting-to-be-bonded position, but also the subsequent die testing and position calibration processes are made easy. Second, the present invention allows a die in a wafer to be directly bonded to a die bonding position on a substrate from below. This thus dispenses with, the complicated programs and mechanisms otherwise required by a conventional die bonding machine for passing the die to a waiting-to-be-bonded position with a pick-and-place arm. Therefore, the time for transporting the die, and consequently the overall bonding cycle time, can be shortened while the production capacity of the die bonding machine is significantly enhanced.

In short, the present invention provides substantial technical advancement, with obvious and positive effects, and therefore is a novel, inventive, and useful design.

The above description is only a summary of the technical solution of the present invention. A detailed description of the preferred embodiment is provided below by reference to the accompanying drawings to shed more light on the technical means of the present invention, so that a person skilled in the art can easily understand the above and other objects, features, and advantages of the present invention and is enabled to implement the present invention according to the contents disclosed herein.

### BRIEF DESCRIPTION OF THE SEVERAL VIEWS OF THE DRAWINGS

FIG. 1 is a perspective view of a die ejecting device disclosed in Taiwan Patent (Utility Model) No. 335788;

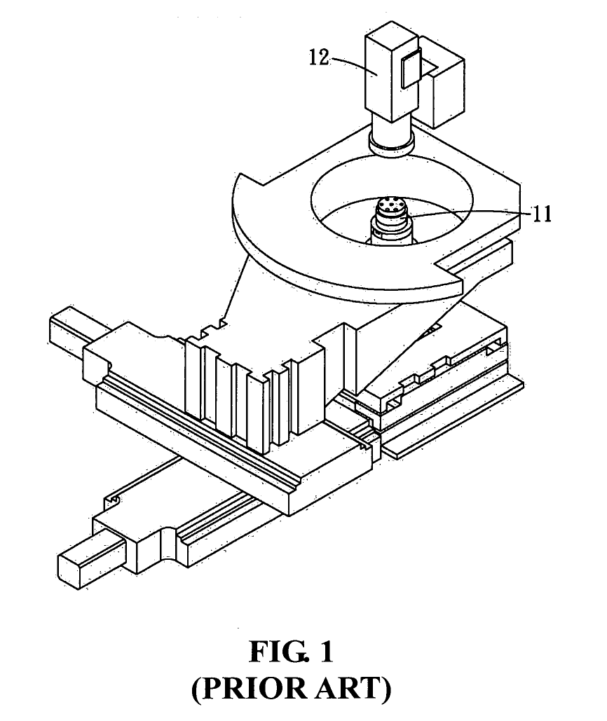

FIG. 2 is a side view of a convention assembly of a die ejecting device and an image capture device;

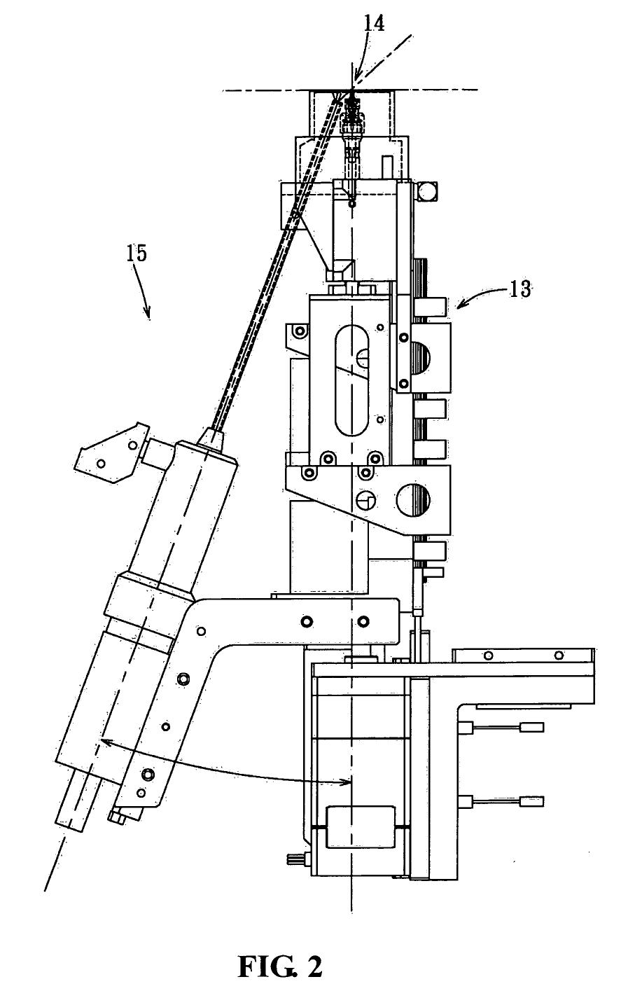

FIG. 3 is a side view of a preferred embodiment of the present invention;

FIG. 4 is a partial enlarged view of FIG. 3; and

FIG. 5 shows a die bonding machine using the present invention.

### DETAILED DESCRIPTION OF THE INVENTION

The technical means adopted by the present invention to achieve the intended object, as well as the effects attained, are further expounded through the following detailed description, provided by reference to the accompanying drawings, of the implementation mode, structure, characteristics, and effects of an assembly of a die ejecting device and an image capture device according to a preferred embodiment of the present invention.

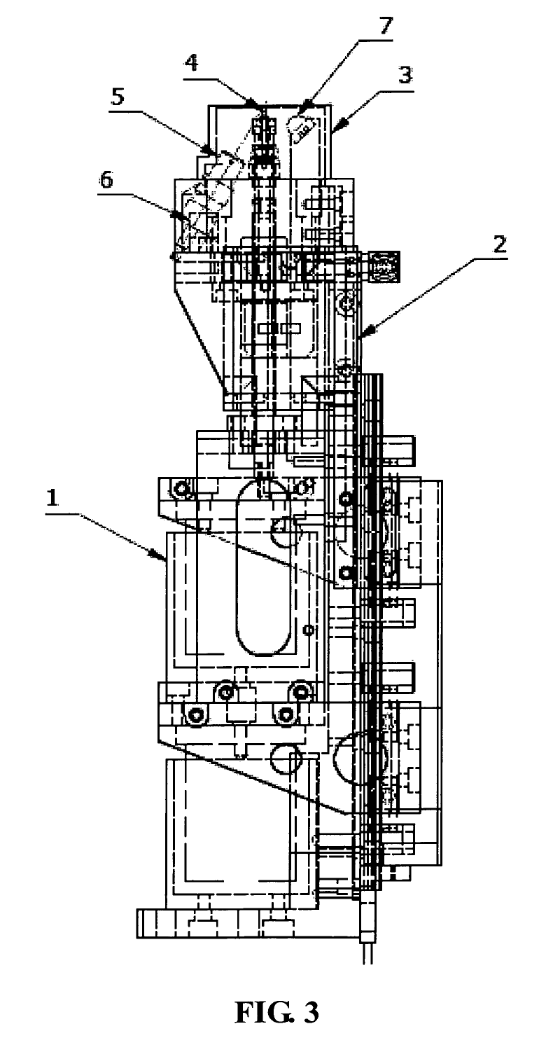

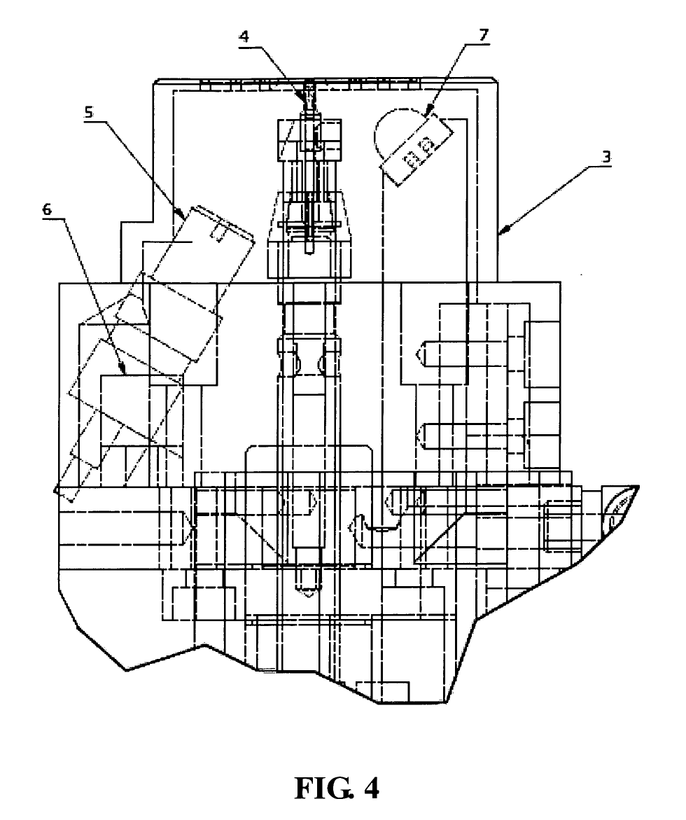

Please refer to FIG. 3 and FIG. 4 for an assembly of a die ejecting device and an image capture device according to the preferred embodiment of the present invention. The assembly includes an ejector main body 2, a die ejecting device 3 provided on the ejector main body 2, and an image capture device, wherein the die ejecting device 3 is configured to eject a die adhered to a tape (e.g., a blue tape), and the image capture device is configured to take images of the ejected die so as to calibrate the position of the die.

The die ejecting device 3 includes a needle unit 4 and a driving unit 1. The needle unit 4 is disposed at a top end of the die ejecting device 3 and faces upward toward a needle passing hole formed on an ejecting stage of the die ejecting device 3. The driving unit 1 includes a motor provided in the ejector main body 2. The motor is located below the needle unit 4 and configured for driving the needle unit 4 upward and downward in relation to the ejecting stage, such that the needle unit 4 is projected upward from the ejecting stage through the needle passing hole or is drawn downward into the ejecting stage.

The image capture device is provided inside the die ejecting device 3 and configured for simultaneously taking images of a die in a wafer and of a waiting-to-be-bonded position directly from below the wafer. Therefore, the tape and the waiting-to-be-bonded position can be positioned in a bottom-to-top order, the die can be bonded to a die bonding position on a substrate from below the wafer, and the position of the bonded die can be verified. In consequence, the complicated programs and mechanisms otherwise required by a conventional die bonding machine for conveying the die to a waiting-to-be-bonded position with a pick-and-place arm can be dispensed with, thereby significantly reducing the time for transporting the die, shortening the overall bonding cycle time, and substantially increasing the production capacity of the die bonding machine.

In the present embodiment, the image capture device includes an image capture element 5, a fixing mount 6, and a light source 7. In the present embodiment, the image capture element 5 is a CCD camera while the light source 7 is an LED light source. The image capture element 5 is fixed at the fixing mount 6. The light source 7 is located adjacent to the image capture element 5 (i.e., to a lateral side of the image capture element 5) so that, when the die is pushed upward by the needle unit 4, light coming from the light source 7 can pass through the needle passing hole and illuminate the die.

With the image capture element 5 and the light source 7 being arranged as above, when the needle unit 4 is driven to protrude upward from the ejecting stage though the needle passing hole and thereby pushes the die upward, light provided by the light source 7 is shone on the die through the needle passing hole. Then, the light is reflected by the die back to the image capture element 5, thus allowing the image capture element 5 to take images of the die being pushed upward by the needle unit 4. After that, the image capture element 5 outputs the images to a computer for subsequent calibration and calculation of the die's dimension and position.

According to the embodiment of the present invention, the miniature image capture element 5 and the internal light source system are housed in the ejecting stage. Locating the image capture element 5 and the light source 7 inside the ejector main body 2 facilitates subsequent die testing and position calibration. Hence, spatial utilization is optimized to effectively reduce the volume of the module.

As the image capture element 5 according to the embodiment of the present invention is fixed inside a needle cover of the ejector main body 2, the space required is significantly decreased. Moreover, the working stroke of an outside wafer table is increased, and the otherwise complicated die bonding procedure of transporting a die to a waiting-to-be-bonded position after images of the die are taken can be eliminated. As a result, the time for transporting the die is substantially shortened, the overall bonding cycle time is reduced, the production capacity of the die bonding machine is greatly enhanced, and the object of the present invention is thus achieved.

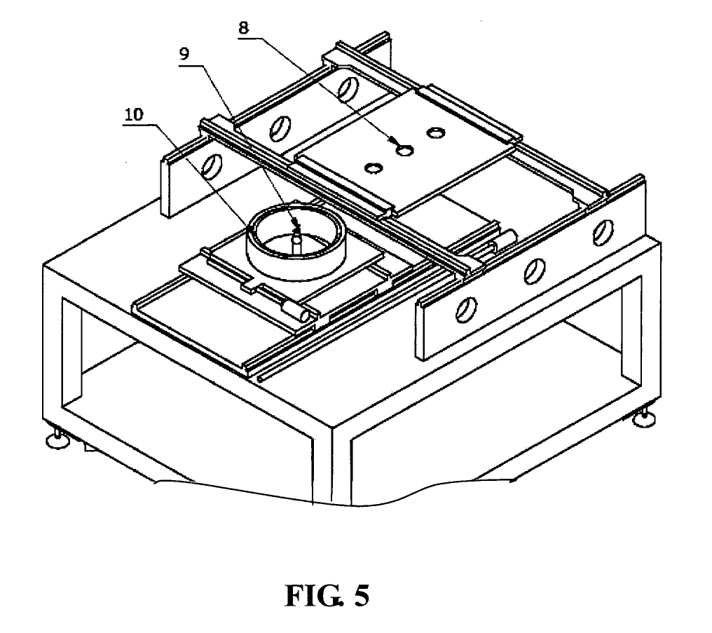

In the embodiment of the present invention, a vacuum suction plate 8 is designed or replaceable according to the dimensions of the device being manufactured and therefore is applicable to substrates of varying sizes. As shown in FIG. 5, the die ejecting device 3 and a wafer table 9 can be directly moved to under the vacuum suction plate 8. After the image capture element 5 takes images of a die, and the subsequent calibration and calculation of the die's dimension and position are accomplished, the vacuum suction plate 8 and the wafer table 9 are moved respectively along the X- and Y-axes to transport a substrate and the die to the desired positions for die bonding. Thus, the present invention is suitable for use in a die bonding process involving dies of very small sizes.

By virtue of the blue tape (or transparent tape) on which wafers are mounted, the embodiment of the present invention can be used with different kinds of substrates to which dies are commonly bonded, such as printed circuit boards (PCBs), flexible printed circuit (FPC) boards, glass substrates, and lead frames. Furthermore, the embodiment of the present invention is applicable to large substrates with which conventional mechanisms cannot be used and, as the conventional pick-and-place arm is no longer required, it is equally applicable to the bonding process of very small dies.

The embodiment described above is only the preferred embodiment and imposes no limitations whatsoever on the present invention. While the present invention is described herein by reference to the preferred embodiment, it is understood that the embodiment is not intended to limit the scope of the present invention, which is defined only by the appended claims. As a person skilled in the art can make minor or equivalent changes or modifications to the described embodiment according to the technical contents disclosed herein without departing from the scope of the present invention, all such changes or modifications should be encompassed by the appended claims.

What is claimed is:

1. An assembly of a die ejecting device and an image capture device, characterized by comprising:
an ejector main body;
the die ejecting device provided on the ejector main body and configured to eject a die adhered to a tape; and
the image capture device provided in the die ejecting device and comprising:
an image capture element for taking images of the ejected die; and
a light source.

2. The assembly of claim 1, wherein the die ejecting device comprises:
an ejecting stage having a needle passing hole;
a needle unit provided below the ejecting stage; and
a driving unit for driving the needle unit to project upward from the ejecting stage through the needle passing hole.

3. The assembly of claim 1, wherein the light source is provided to a lateral side of the image capture element.

4. The assembly of claim 1, wherein the light source is a light-emitting diode (LED) light source.
